(19) United States
(12) Patent Application Publication
(10) Pub. No.: US 2025/0344028 A1
(43) Pub. Date: Nov. 6, 2025

(54) HEARING INSTRUMENT WITH ANTENNA AND CAPACITIVE CONTROL UNIT

(71) Applicant: Sivantos Pte. Ltd., Singapore (SG)

(72) Inventors: Peter NIKLES, Erlangen (DE); Hamed HASANI, Erlangen (DE); Andreas PFROMMER, Erlangen (DE)

(21) Appl. No.: 19/198,338

(22) Filed: May 5, 2025

(30) Foreign Application Priority Data
May 3, 2024 (DE) 10 2024 204 158.0

(51) Int. Cl. H04R 25/00; H01Q 1/27

(52) U.S. Cl. CPC H04R 25/554; H01Q 1/273; H04R 2225/51

(57) ABSTRACT

A hearing instrument has a housing to be worn behind or in a user's ear. The housing contains a wireless communication device with a transmitting and receiving unit and an antenna electrically connected thereto, and a capacitive control unit with a control and evaluation circuit and an electrode arrangement electrically connected thereto. The antenna of the wireless communication device and the electrode arrangement of the capacitive control unit are one and the same. The antenna has two antenna sections that are galvanically separated from one another and the two antenna sections are separately connected to the capacitive control unit and form different electrodes of the electrode arrangement.

### CROSS-REFERENCE TO RELATED APPLICATION

This application claims the priority, under 35 U.S.C. § 119, of German Patent Application DE 10 2024 204 158.0, filed May 3, 2024; the prior application is herewith incorporated by reference in its entirety.

### FIELD AND BACKGROUND OF THE INVENTION

The invention relates to a hearing instrument with a housing that is worn behind a user's ear or in the user's ear.

A hearing instrument is generally defined as an electronic device that supports the hearing ability of a person wearing the hearing instrument (hereinafter referred to as the “wearer” or “user”). In particular, the invention relates to hearing instruments designed to fully or partially compensate for a hearing loss of a hearing-impaired user. Such a hearing instrument is referred to as a “hearing aid.” Hearing instruments also exist which protect or improve the hearing of users with normal hearing, for example by enabling improved speech comprehension in complex listening situations. Hearing instruments also include wireless headphones (worn in or on the ear), in particular, so-called ear plugs and headsets.

Hearing instruments in general, and hearing aids in particular, are usually designed to be worn on the head and in or on an ear of the user, in particular as behind-the-ear devices (also known as BTE devices) or in-the-ear devices (also known as ITE devices). With regard to their internal structure, hearing instruments regularly have at least one (acousto-electrical) input transducer, one signal processing unit (signal processor), and one output transducer. During operation of the hearing instrument, the or each of the input transducers receives airborne sound from the environment of the hearing instrument and converts this airborne sound into an (input) audio signal (i.e., an electrical signal that carries information about the ambient sound). In the signal processing unit, the or each input audio signal is processed (i.e., modified with regard to its sound information) in order to support the user's hearing ability, in particular to compensate for hearing loss on the part of the user. The signal processing unit outputs an appropriately processed (output) audio signal to the output transducer. In modern hearing instruments, signal processing regularly includes a variety of other functions in addition to or as an alternative to frequency-dependent amplification of the input audio signal, e.g., beamforming (i.e., direction-dependent attenuation), active noise cancellation, wind noise suppression, feedback attenuation, binaural processing to support spatial hearing, dynamic and/or spectral compression, etc.

In most cases, the output transducer is an electro-acoustic transducer which converts the (electrical) output audio signal back into airborne sound, this airborne sound—modified compared to the ambient sound—being emitted into the user's auditory canal. In a hearing instrument worn behind the ear, the output transducer, also known as the receiver, is usually integrated outside the ear in a housing of the hearing instrument. In this case, the sound emitted by the output transducer is directed into the user's auditory canal via a sound tube. Alternatively, the output transducer can also be located in the auditory canal and thus outside the housing worn behind the ear. Such hearing instruments are also called RIC (receiver-in-canal) devices. Hearing instruments worn in the ear that are so small that they do not protrude beyond the auditory canal are also called CIC (completely-in-canal) devices.

In other hearing instrument designs, the output transducer can also be embodied as an electro-mechanical transducer that converts the output audio signal into structure-borne sound (vibrations), this structure-borne sound being emitted, for example, into the user's cranial bone.

Modern hearing instruments usually have a wireless communication device by means of which the hearing instrument can wirelessly exchange data with one or more peripheral devices, e.g., another hearing instrument for supplying the user's other ear or with a mobile phone. Such a communication device has an antenna integrated into the housing of the hearing instrument that is designed to transmit and receive electromagnetic waves (radio waves), often in the GHz frequency range. Wireless data transmission usually takes place using the Bluetooth standard (especially the Bluetooth Low Energy standard).

Furthermore, hearing instruments often have a control unit, i.e., an electrical switching element that can be actuated by a manual action to generate a command for operating the hearing instrument (e.g., a command to switch on or off, a command to change the gain of the output audio signal, and/or a command to change a signal processing program). In order to avoid moving components that are susceptible to failure, capacitive control units are sometimes used. Such a capacitive control unit has an electrode arrangement arranged in the housing of the hearing instrument by means of which an alternating electric field is generated in a spatial volume in front of the housing of the hearing instrument. The function of the capacitive control unit is based on the fact that a user's finger that is brought close to the electrode arrangement or placed on the corresponding point of the housing changes the (electrical) capacitance of the electrode arrangement in a characteristic manner through interaction with the alternating electric field. When this change is detected, the corresponding operating command is triggered by a control and evaluation circuit of the capacitive control unit that is electrically connected to the electrode arrangement.

In order to detect the capacitance change described above, an alternating electrical voltage is generally applied to the electrode arrangement by a control and evaluation circuit of the capacitive control unit by which the alternating electrical field is generated in the vicinity of the electrode arrangement. The control and evaluation circuit measures an electrical response signal (in particular the current strength of the current flow generated by the alternating voltage) as a measure of the capacitance of the electrode arrangement. As for the measurement of the response signal, two common capacitive measurement methods are distinguished:

According to a first measurement method, which may be referred to as a “single-electrode measurement” or “self-capacitance sensing,” the control and evaluation circuit measures the response signal at the same electrode of the electrode arrangement to which it applies the alternating voltage. As a capacitance-dependent response signal, the control and evaluation circuit measures, for example, the current flowing to this electrode under the effect of the alternating voltage or the frequency of the alternating voltage (taking advantage of the fact that the sensor electrode is part of an oscillating circuit with a resonance that varies as a function of the capacitance). In all cases, the response signal is characteristic of the (electrical) capacitance of the electrode relative to an external ground potential. During “single-electrode measurement,” the external ground potential, which is formed here by the user's body, for example, acts as the counter electrode of the capacitor whose capacitance is being measured.

According to a second measurement method, which may be referred to, for example, as “two-electrode measurement,” the “transmitter-receiver principle,” or “relative capacitance measurement” (mutual capacitance sensing), the control and evaluation circuit applies the alternating voltage to a first electrode (i.e., the transmitting electrode) of the electrode arrangement and measures the response signal at another electrode (i.e., the receiving electrode) of the electrode arrangement. In this case, the control and evaluation circuit measures, for example, the current intensity generated in the receiving electrode under the effect of the alternating electric field as a capacitance-dependent response signal. The response signal is characteristic of the (electrical) capacitance of the capacitor formed by the transmitting electrode and the receiving electrode. In “two-electrode measurement,” parts of the user's body (especially a finger approaching the electrode arrangement) act as an interference potential that changes the capacitance of the capacitor formed by the two sensor electrodes and is thereby detected.

In all of the cases described above, the simultaneous arrangement of the antenna of the wireless communication device and the electrode arrangement of the capacitive control unit is problematic, since both structures must necessarily occupy a comparatively large proportion of the very limited installation space in the hearing instrument housing in order to function effectively. What makes matters more difficult is that the same areas of a hearing instrument are preferred for both the arrangement of the antenna of the wireless communication device and the arrangement of the electrode arrangement of the capacitive control unit, namely areas directly on or near the housing wall that are freely accessible from the outside in or on the user's ear when the hearing instrument is in the intended wearing position. This problem is especially critical in the case of an ITE device, in which the antenna and the electrode arrangement can be positioned almost exclusively on the front surface of the housing that faces outward when the hearing instrument is inserted. A non-overlapping arrangement of the antenna and the electrode arrangement (i.e., an arrangement with sufficient spacing from one another) is often not possible due to space constraints or at least is disadvantageous due to mutual interference. An overlapping arrangement of the antenna and the electrode arrangement would in turn lead to mutual impairment of the functionality of the antenna and electrode arrangement.

Published patent application US 2020/0314525 A1 describes a hearing aid which detects a tap on the hearing aid housing based on inputs from at least two sensors. The tap can be a single or double tapping gesture. In response to the single or double tap, the hearing aid may perform a function to modify the device (e.g., change the mode, change a setting, play a tone, or perform a task). The first sensor may be an accelerometer that detects a change in acceleration of the hearing aid, and the second sensor may be a capacitive sensor. The hearing aid further comprises an antenna which can be used as a second sensor.

Published patent application US 2023/0328466 A1 and its counterpart German published patent application DE 10 2022 203 528 A1 disclose a hearing aid, in particular an in-the-ear hearing aid. That hearing aid has a device housing with a housing shell that can be inserted into an ear canal, as well as a housing front plate that seals the housing shell. The hearing aid further comprises a battery which is accommodated in the device housing, a signal processing device with a ground plane being arranged at least partially between the battery and the housing front plate. The hearing aid also has an antenna device with at least two folded antenna arms that is arranged between the ground plane and the housing front panel. The antenna arms extend as spatial spirals or helices along a height direction perpendicular to the ground plane and have at least one winding or one turn, the antenna arms being electrically connected to one another by antenna poles that are arranged at a distance from the ground plane.

### SUMMARY OF THE INVENTION

It is the object of the invention to provide a hearing instrument that is equipped with both an effective wireless communication device and an advantageous control unit.

With the above and other objects in view there is provided, in accordance with the invention, a hearing instrument, comprising:
a housing to be worn behind or in a user's ear;
a wireless communication device disposed in the housing, the wireless communication device having a transmitting and receiving unit and an antenna electrically connected to the transmitting and receiving unit; and
a capacitive control unit with a control and evaluation circuit and an electrode arrangement electrically connected to the control and evaluation circuit;
the antenna of the wireless communication device also forming the electrode arrangement of the capacitive control unit, with the antenna having two antenna sections that are galvanically separated from one another, and the two antenna sections being electrically connected, separately from one another, to the control and evaluation circuit of the capacitive control unit and forming different electrodes of the electrode arrangement.

In other words, the invention relates to a hearing instrument with a housing that is to be worn in a designated wearing position behind or in a user's ear. The hearing instrument can therefore in principle also be a BTE device as described at the outset. In this case, in addition to the housing worn behind the ear, the hearing instrument usually comprises an earpiece to be placed in the user's ear and a flexible connecting part that connects the housing and the earpiece. In this case, the hearing instrument is either a classic hearing instrument with a receiver located in the housing or an RIC device in which the receiver is located in the earpiece. In the former case, the connecting piece is formed by a sound tube that conducts the sound produced by the receiver to the earpiece. In the latter case, the connector is an electrical connecting cable through which the output audio signal is transmitted to the receiver located in the earpiece. However, the hearing instrument is preferably embodied as an ITE device. The particularly compact design of the antenna combined with the electrode arrangement of the capacitive control unit is especially advantageous in such devices due to the very limited installation space.

In all of the embodiments described above, a wireless communication device and a capacitive control unit continue to be arranged in the housing.

The wireless communication device is used for wireless signal exchange (particularly data exchange) between the hearing instrument and a peripheral device—e.g., another hearing instrument or smartphone of the user—and comprises an antenna and an electrically connected transmitting and receiving unit (transceiver).

The capacitive control unit comprises an electrode arrangement with at least one sensor electrode and a control and evaluation circuit electrically connected to the electrode arrangement (also referred to as “sensor control” or “sensor controller”). The capacitive control unit is designed to detect the approach of a user's finger to the housing or a touch or pressure exerted by the finger on the housing as a signaling of an operating command and, in this case, to generate a corresponding operating command for the hearing instrument. For example, the operating command causes the hearing instrument or a specific hearing instrument function to be switched on and/or off or brings about a change in the amplification of the output audio signal (and hence the volume of the sound perception generated by the hearing instrument) or a switch between different signal processing programs. The function of the command device is optionally defined in a context-dependent manner, so that actuating the command device can trigger different actions in different situations. In addition or alternatively, the function of the command device is implemented dependently on the type of operating event, so that, for example, a longer-lasting approach event triggers a different action than a simple approach of short duration and/or a multiple approach event of short duration. In principle, the capacitive control unit can be embodied as a proximity switch that generates the operating command when a user's finger is brought within a certain distance (e.g., less than 2 mm) of the housing without touching it. In order to avoid incorrect triggering of the operating command (i.e., unwanted by the user), the capacitive control unit is preferably embodied as a touch switch that triggers the operating command only when the housing is touched, in particular (optionally) only when the housing is deformed under the pressure of the touch.

In order to enable both the antenna of the wireless communication device and the electrode arrangement of the capacitive control unit to be advantageously arranged in the housing of the hearing instrument without these structures interfering with one another, the antenna of the wireless communication device and the electrode arrangement of the capacitive sensor are identical in the hearing instrument according to the invention. In other words, the entire antenna is also utilized as an electrode arrangement, and the entire electrode arrangement is also utilized as an antenna. To put it yet another way, there is no part of the antenna that is not also used as part of the electrode arrangement, and there is no part of the electrode arrangement that is not also used as part of the antenna. The available space within the housing is thus utilized particularly well for arranging the antenna and the electrode arrangement.

The antenna comprises two antenna sections that are galvanically separated from one another, so that no direct exchange of electrons between the two antenna sections is possible. The two antenna sections are electrically connected separately from one another to the control and evaluation circuit of the capacitive control unit as different sensor electrodes of the sensor electrode arrangement.

The capacitive control unit preferably employs the “relative capacitance measurement” method described above. In that case, the two antenna sections serve as different sensor electrodes, namely as the transmitting electrode and receiving electrode of the capacitive control unit. The control and evaluation circuit of the capacitive control unit is designed to apply the sensor voltage to one of the two sensor electrodes (namely the transmitting electrode) and to measure a response signal characteristic of the capacitance of the electrode arrangement at the other sensor electrode (namely the receiving electrode). As a response signal, the control and evaluation circuit measures in particular the current intensity generated in the receiving electrode under the effect of the sensor signal and the resulting electric field.

In order to avoid mutual interference between the wireless communication device and the capacitive control unit during operation of these units in a simple but effective manner, the wireless communication device and the capacitive control unit are preferably designed for significantly different (electrical) frequencies. Specifically, the transmitting and receiving unit of the wireless communication device is configured to generate and receive a first electrical alternating-current signal (e.g., a voltage or current signal) at a first frequency, while the control and evaluation circuit of the capacitive control unit is configured to generate a second electrical alternating-current signal (that is, a voltage or current signal, for example) at a second frequency. The first frequency is higher than the second frequency by at least a factor of 10, preferably at least a factor of 100. For example, the first frequency is greater than 100 MHz, preferably greater than 1 GHz, in particular 2.4 GHz. The communication device is designed in particular to send and receive data according to the Bluetooth standard. The second frequency, on the other hand, is less than 10 MHz, for example, particularly 100 KHz. For the sake of easier conceptual differentiation, the first alternating-current signal will also be referred to as the “radio signal” below, whereas the second alternating-current signal will also be referred to as the “sensor signal.” Accordingly, the first frequency will also be referred to as the “radio frequency” and the second frequency will also be referred to as the “sensor frequency.”

A design of the antenna in the form of a multiple spiral has proven to be especially advantageous in terms of high antenna efficiency and compact size. In these embodiments of the invention, the antenna comprises at least two spiral arms which are wound into one another and widen in particular in a center of the spiral, for example to form a partially circular disc-shaped (in the case of two spiral arms, in particular a semicircular disc-shaped) or comb-shaped central structure. In an alternative embodiment of the invention, the antenna is embodied as a butterfly antenna (bowtie antenna).

In a preferred embodiment of the invention, the antenna is mounted on a convex, in particular dome-shaped antenna support. The antenna support can optionally be designed to be elastically deformable. At least in this case, it is arranged in the housing of the hearing instrument in such a way that it is deformed through exertion of pressure on the housing, in particular by means of a user's finger. In this embodiment, the capacitance of the electrode array is changed not only by the approach of the finger to the electrode array, but also by the deformation of the electrode array due to the applied pressure. The change in the response signal measured by the capacitive command sensor used to detect a user command is thereby amplified, which in turn reduces the probability of an unwanted false triggering of the capacitive command sensor.

Other features which are considered as characteristic for the invention are set forth in the appended claims.

Although the invention is illustrated and described herein as being embodied in a hearing instrument with an antenna and a capacitive control unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a perspective view of a hearing instrument embodied as an ITE device with a housing to be worn in the ear of a user, in which there are arranged a wireless communication device for RF signal transmission with a transmitting and receiving unit and an antenna electrically connected thereto, and a capacitive control unit with a control and evaluation circuit and an electrode arrangement electrically connected thereto, the antenna of the wireless communication device being identical to the electrode arrangement of the capacitive control unit;

FIG. 2 shows the hearing instrument in a schematically simplified cross section taken along the line II-II in FIG. 1 and viewed in the direction of the arrows;

FIG. 3 shows the hearing instrument in a schematically simplified cross section taken along the line III-III in FIG. 1 and viewed in the direction of the arrows;

FIG. 4 shows a perspective view of an embodiment of the antenna in which it is designed in the form of a double spiral whose two spiral arms are mounted on a dome-shaped antenna support, the two spiral arms being used as different electrodes of the electrode arrangement;

FIG. 5 shows the antenna of FIG. 4 without the antenna support;

FIG. 6 shows a schematically simplified plan view of the antenna of FIG. 4;

FIG. 7 shows a schematic representation of the communication device and the capacitive control unit of the hearing instrument during use of the antenna of FIG. 4 for RF signal transmission;

FIG. 8 shows, in a schematic illustration similar to FIG. 7, the communication device and the capacitive control unit of the hearing instrument during use of the antenna of FIG. 4 as the electrode arrangement of the capacitive control unit;

FIG. 9 shows, in a schematic illustration similar to FIG. 7, the communication device and the capacitive control unit of the hearing instrument in an alternative connection of the transceiver and the sensor control to the antenna;

FIG. 10 shows, in a schematic illustration similar to FIG. 6, a variant of the antenna of FIG. 6;

FIGS. 11 and 12 show further variants of the antenna of FIG. 6; and

FIG. 13 shows a schematic representation of an alternative embodiment of the antenna, with the antenna embodied as a butterfly antenna.

Analogous parts and quantities are provided with the same reference symbols throughout the figures.

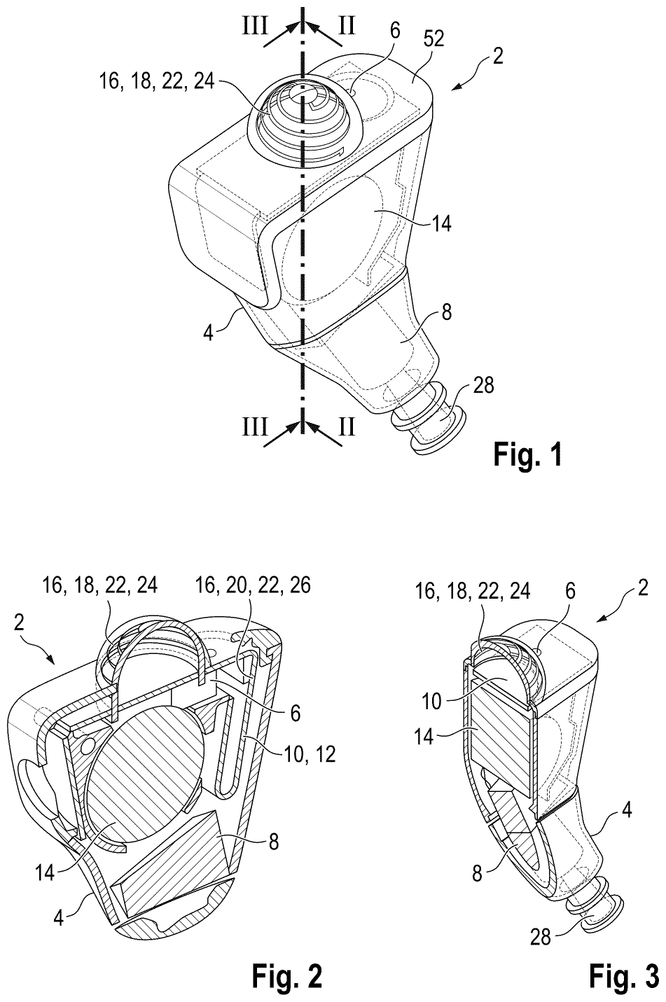

Referring now to the figures of the drawing in detail and first, in particular, to FIGS. 1 to 3 thereof, there is shown a rough schematic representation of a hearing instrument 2, which is, for example, a hearing aid; i.e., a hearing instrument that designed to support the hearing of a hearing-impaired user. In the embodiment shown here, the hearing instrument 2 is an ITE device. It therefore comprises a housing 4 which is intended to be worn in an ear of a user.

Within the housing 4, the hearing instrument 2 has the following components:
at least one microphone 6 as an input transducer,
at least one loudspeaker (receiver 8) as an output transducer,
a (flexible) printed circuit board 10 with a (digital) signal processor 12,
a battery 14,
a wireless communication device 16 with an (RF) antenna 18 and a transmitting and receiving unit (transceiver 20) electrically connected thereto, and
a capacitive control unit 22, which is formed from an electrode arrangement 24 and a control and evaluation circuit (sensor control 26) electrically connected thereto.

During the normal operation of the hearing instrument 2, at least one microphone 6 records airborne sound from the surroundings of the hearing instrument 2. The (or each) microphone 6 converts the sound into an (input) audio signal, i.e., into an electrical signal containing information about the recorded sound. The respective input audio signal is fed within the hearing instrument 2 to the signal processor 12, which modifies this input audio signal to support the user's hearing ability, in particular by frequency-selectively amplifying it to compensate for a hearing loss of the user.

The signal processor 12 outputs an output audio signal—i.e., again an electrical signal, which in this case contains information about the processed and thus modified sound—to the receiver 8. The receiver 8 converts the output audio signal into airborne sound and transmits it into the user's auditory canal via a sound channel 28 incorporated in the housing 4.

The signal processor 12 and all other electrical or electronic components of the hearing instrument 2 are supplied by the battery 14 with a direct electrical voltage referred to as the operating voltage.

The wireless communication device 16 serves for the (wireless) exchange of signals (in particular data exchange) between the hearing instrument 2 and at least one electronic peripheral device that interacts with the hearing instrument 2 during operation. The at least one peripheral device is, for example, another hearing instrument for supplying the other ear of the user or a mobile computer, in particular a smartphone of the user, on which a software application (operating app) for programming and/or remotely controlling the hearing instrument 2 is installed.

The wireless communication device 16 of the hearing instrument 2 and a corresponding wireless communication device of the peripheral device are generally designed to exchange radio frequency (RF) signals. An RF signal (or radio signal or radio wave) is electromagnetic radiation with a radio frequency f_{RF} of greater than 100 MHz. Preferably, the data transmission between the hearing instrument 2 and the peripheral device is based on the Bluetooth standard, the radio frequency f_{RF} being 2.4 GHz. For transmission, the transceiver 20 applies an alternating current electrical signal oscillating at the radio frequency f_{RF} (here in the form of an alternating voltage U_{RF}) to the antenna 18. For reception, the transceiver 20 detects corresponding electrical alternating voltage signals that are induced in the antenna 18 under the influence of externally generated electromagnetic fields.

The capacitive control unit 22—e.g., instead of an electromechanical control unit such as a switch, button or rotary knob-serves to detect an operating command transmitted by the user through a manual action (e.g., their fingertip). The capacitive control unit 22 utilizes the antenna 18 as the electrode arrangement 24. For this purpose, the antenna 18 is also electrically connected to the sensor control 26 of the capacitive control unit 22. The sensor control 26 controls the antenna 18 used as the electrode arrangement 24 with an electrical alternating voltage referred to as the sensor voltage US, whose alternating voltage frequency (sensor frequency f_{S}) lies between 20 KHz and 10 MHz and is 100 kHz, for example. The sensor voltage US is thus spectrally spaced between the operating voltage generated by the battery 20 on the one hand and the alternating voltage U_{RF} of the wireless communication device 16 on the other hand.

The signal processor 12, the transceiver 20, and the sensor controller 26 are each optionally formed by a programmable circuit (e.g., a microprocessor) with software installed on them, by a non-programmable circuit (e.g., in the form of an ASIC), or by a combination of at least one programmable subunit and at least one non-programmable subunit. As indicated by way of example in FIG. 1, the transceiver 20 and the sensor controller 26 are preferably integrated together with the signal processor 12 on the printed circuit board 10. The signal processor 12, the transceiver 20, and the sensor control 26 are either integrated into a common electronic component or embodied as separate circuits.

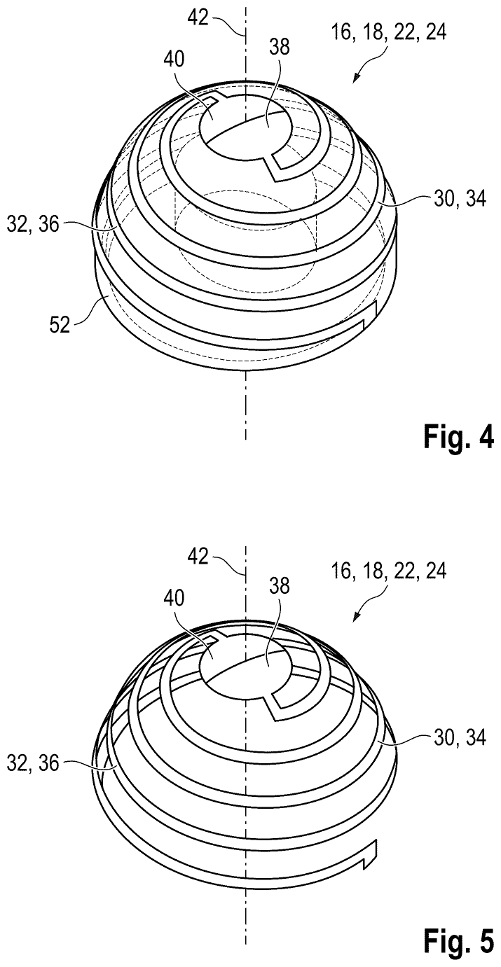

The antenna 18, which is also used as the electrode arrangement 24, is shown in more detail in FIGS. 4 to 6. As can be seen from those illustrations, the antenna 18 is embodied here as a double spiral. Accordingly, it comprises two antenna segments 30, 32 in the form of two intertwined spiral arms which, on the one hand, cooperate within the framework of the communication device 16 to transmit and receive RF signals and, on the other hand, form various electrodes 34 and 36 of the electrode arrangement 24 of the capacitive control unit 22. The shape of the antenna 18 preferably corresponds at least approximately to an Archimedean spiral. However, the shape of the antenna 18 may also correspond to or resemble another mathematical spiral shape, such as a logarithmic spiral (also referred to as an “equiangular spiral” or “self-similar spiral”). In addition, the spiral arms can have either a constant or varying width.

The two antenna segments 30, 32 meet in the center of the spiral. In the example according to FIGS. 4 to 6, the two antenna segments 30 and 32 are each widened in this center to form a semicircular disc-shaped central structure (central surface 38 and 40, respectively). The central surfaces 38, 40 primarily serve to increase the capacitance of the capacitor formed by the antenna segments 30, 32 (or electrodes 34, 36). They are arranged in the center of the spiral shape in such a way that they complement each other to form a circular disc-like shape. Preferably, however, the two central surfaces 38 and 40 are galvanically separated from one another by a thin slit. In other words, the two central surfaces 38 and 40 are electrically unconnected, so that no transfer of electrons between the central surfaces 38 and 40 is possible.

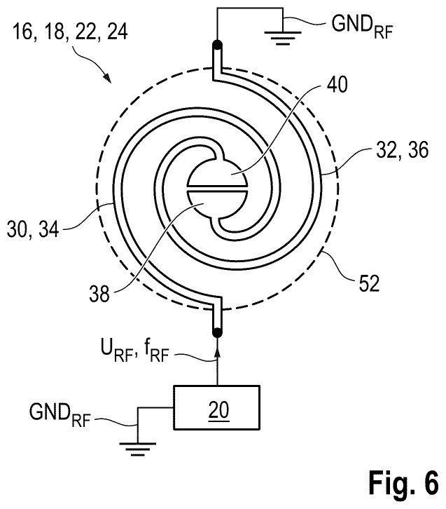

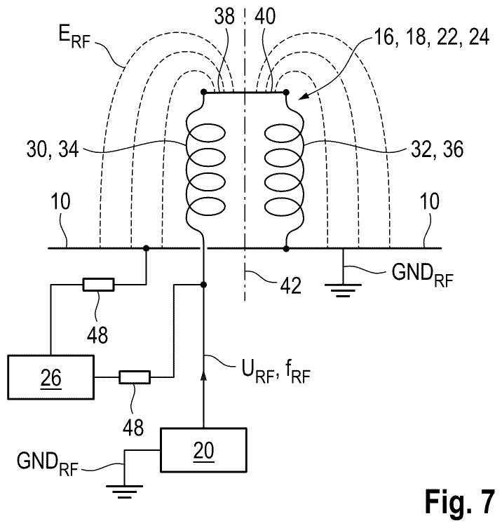

To utilize the antenna 18 for transmitting RF signals within the communication device 16, the transceiver 20 applies the alternating voltage U_{RF} to the outer end of the antenna segment 30 according to FIGS. 6 and 7, while the outer end of the antenna segment 32 is connected to the ground potential GND_{RF} of the communication device 16, which is formed on the printed circuit board 10, for example. Under the effect of the alternating voltage U_{RF} applied to the antenna segment 30, the antenna 18 shown in FIGS. 4 to 6 radiates an electromagnetic field approximately symmetrical to the axis 42 of the spiral shape, whose electrical component E_{RF} is indicated in FIG. 7. The galvanic isolation between the two central surfaces 38 and 40 acts as a high-pass filter and is thus permeable to the high-frequency alternating voltage U_{RF}.

In an alternative embodiment (not shown in detail), the antenna 18 is energized centrally. In that case, the supply lines for applying the alternating voltage U_{RF} and the ground potential GND_{RF} are each connected to the inner end of the antenna segment 30 and the antenna segment 32, respectively.

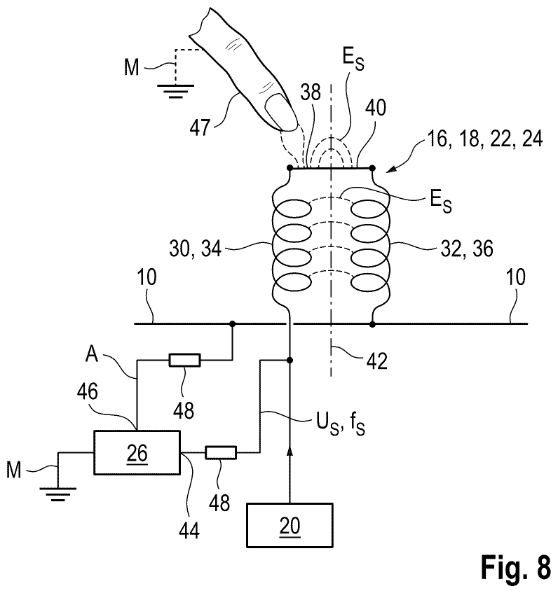

In order to use the antenna 18 as an electrode arrangement 24 for the capacitive control unit 22, the sensor control 26 according to FIG. 8 is electrically connected via a control output 44 to the outer end of the antenna segment 30 (here used as an electrode 34) and applies the sensor voltage US to the antenna segment 30 (or the electrode 34) via that. The other antenna segment 32 used as electrode 36 is connected via the printed circuit board 10 to a measurement input 46 of the sensor control 26. As indicated in FIG. 8, an electric sensor field E S is formed under the effect of the sensor voltage US, between the antenna segments 30 and 32 (or the electrodes 34 and 36), and here above all between the central surface 38 and the central surface 40.

The antenna segments 30 and 32 (or electrodes 34 and 36) thus cooperate to form a capacitor. Via the measurement input 46, the sensor control 26 measures the current intensity of the current flowing between the antenna segments 30 and 32 (or electrodes 34 and 36) as a response signal A, this response signal A being characteristic of the (electrical) capacitance of the capacitor formed by the electrodes 34 and 36. The capacitive control unit 22 is thus embodied in the example according to FIGS. 4 to 8 as a so-called “relative capacity sensor” (mutual capacity sensor). Here, the antenna segment 30 acts as a “transmitting electrode,” and the antenna segment 32 acts as a “receiving electrode.”

The function of the capacitive control unit 22 in this embodiment is based on the fact that body structures of the user arranged close to the antenna 18 (particularly a finger 47, indicated schematically in FIG. 8) act as an interference potential due to the alternating current conductivity of the human body and the indirect electrical connection of the body to the sensor control 26 via ground M, which reduces the capacitance of the capacitor formed by the sensor electrodes 34 and 36 and hence the value of the measured response signal A more the closer the body structure is arranged to the antenna 18. The sensor control 26 is designed to detect an operating command from the user when the response signal A or the capacity derived therefrom falls below a predetermined threshold value for a time interval within predetermined limits (e.g., 1 to 2 seconds).

The communication device 16 and the capacitive control unit 22 are preferably operated in parallel (i.e., simultaneously with one another). Simultaneously with its function of transmitting and receiving RF signals, the antenna 18 thus acts as an electrode arrangement 24 of the capacitive control unit 22. Mutual interference between the communication device 16 and the capacitive control unit 22 is prevented by the spectral separation of the sensor frequency fS from the radio frequency f_{RF}. In order to decouple the sensor control 26 from high-frequency signals, a frequency-selective electrical filter (here in the form of an electrical low-pass filter 48) is connected at least between the antenna section 32 and the measurement input 46, which is permeable to the sensor voltage US but blocks high-frequency electrical signals in the frequency range of the radio frequency f_{RF}. Preferably, such a filter is also connected between the antenna section 30 and the control output 44.

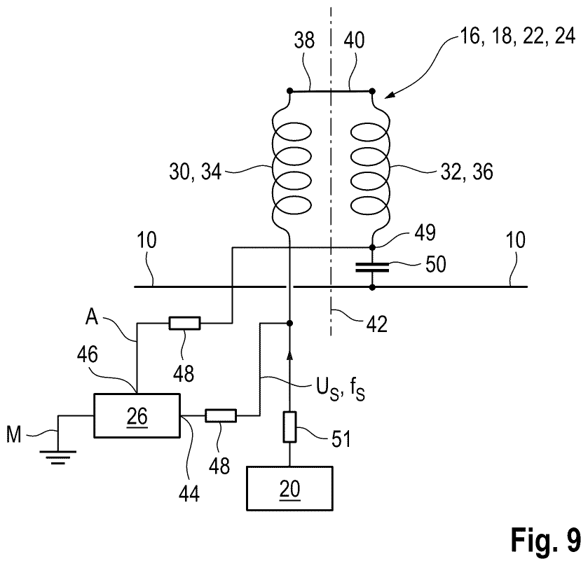

Unlike in FIGS. 6 and 7, in a design variant according to FIG. 9, the measurement input 46 of the sensor control 26 is not connected to the printed circuit board 10 but rather directly to a connection point 49 at the peripheral end of the antenna segment 32 (bypassing the printed circuit board 10) via the low-pass filter 48. In order to electrically decouple the sensor control 26 even more effectively from the printed circuit board 10, a high-pass filter 50 (shown here in the form of a capacitor) is connected between the connection point 49 and the printed circuit board 10 which is permeable to high-frequency electrical signals in the frequency range of the radio frequency f_{RF} but blocks signals in the spectral range of the sensor frequency fs. Any potentially disruptive influence of the printed circuit board 10 on the capacitance measured by the sensor control 26 is thus avoided. In addition or alternatively, another high-pass filter 51 is connected upstream from the transceiver 20 which is also permeable to high-frequency electrical signals in the frequency range of the radio frequency f_{RF} but blocks signals in the spectral range of the sensor frequency fs. The high pass filter 51 serves to protect the transceiver 20 from low-frequency interference.

As can be seen above all from FIGS. 2, 4, and 5, the spiral antenna 18 in the example shown therein is mounted on a dome-shaped (antenna) support 52.

Within the housing 4 of the hearing instrument 2, the support 52 provided with the antenna 18 is arranged according to FIGS. 1 to 3 directly below an end face 53 of the housing 4, which, when the hearing instrument 2 is worn in the intended manner, points outward in the user's auditory canal. The support 52 lies in a correspondingly shaped bulge of the end face 53.

In one embodiment of the hearing instrument 2, the support 52 is optionally formed from an elastically deformable material, in particular a (preferably hollow) elastomer body. In this design variant, the end face 53 or at least the bulge thereof is preferably also formed from an elastically deformable material, so that both the bulge and the underlying support 52 are deformed by finger pressure on the bulge. As a result of this deformation of the support 52 and the electrode arrangement 24 mounted thereon, the capacitance difference measured by the capacitive control unit 22 is further amplified as a result of the approach of the finger. Preferably, the capacitive control unit 22 is embodied as a selective pressure sensor which detects an operating command from the user only when the user presses in the bulge of the front surface 53 using a finger (and thus does not merely bring the finger closer to the front surface 53). This reduces the probability of an unintentional false triggering of the command device, for example due to an involuntary hand movement of the user.

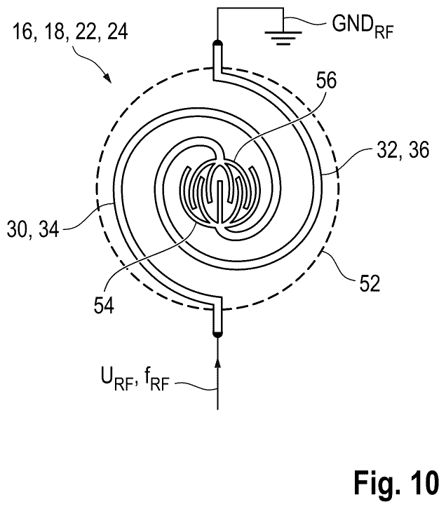

FIG. 10 shows a variant of the spiral antenna 18 according to FIGS. 4 to 6. The variant according to FIG. 10 differs from the embodiment described above in that the antenna segments 30 and 32, instead of the semicircular disc-shaped central surfaces 38 and 40, each have a plurality of fanning-out arms 54 and 56, respectively, which interlock in a comb-like manner to form the central structure of the spiral. In terms of the function as the antenna 18 of the communication device 16 and the electrode arrangement 24 of the control unit 22, this variant corresponds to the embodiment of FIGS. 4 to 6.

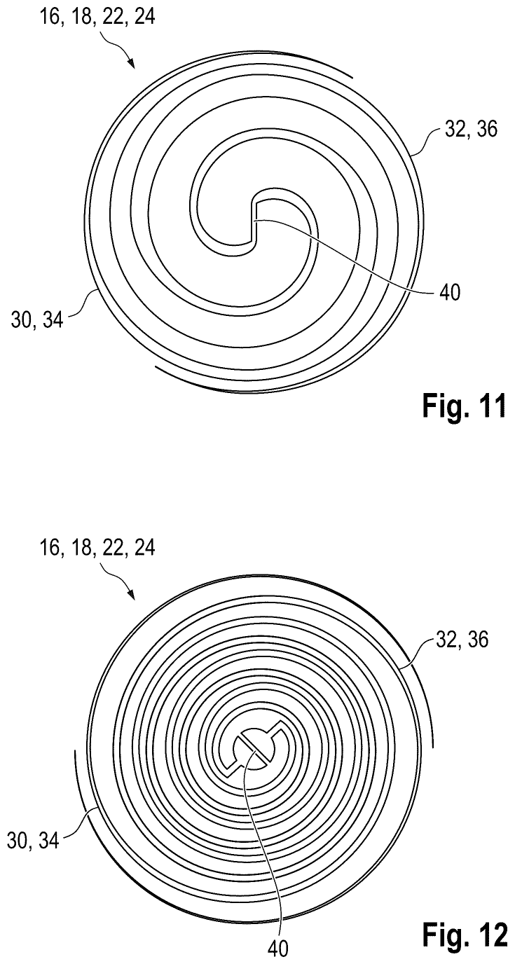

FIG. 11 shows another variant of the spiral antenna 18 according to FIGS. 4 to 6. The variant according to FIG. 11 differs from the embodiment described above in that the two spiral arms of the antenna segments 30 and 32 have a width which increases from the periphery of the spiral toward the center. Conversely, the distance between the spiral arms decreases from the periphery of the spiral toward the center.

FIG. 12 shows another variant of the spiral antenna 18 according to FIGS. 4 to 6. In this variant, the distance between the spiral arms at the periphery of the spiral increases.

Both embodiments have the consequence that, when the antenna 18 is used as the electrode arrangement 24 of the capacitive control unit 22 (and thus when using the antenna 18 as a capacitor), the contribution caused by the center of the spiral to the (undisturbed) total capacitance of the electrode arrangement 24 is increased, while the capacitance contribution caused by the periphery of the spiral is reduced. The sensitivity of the capacitive control unit 22 to the intended operating events, in particular the approach of a user's finger to the electrode arrangement 24, is thereby increased. On the other hand, the sensitivity of the capacitive control unit 22 to interference factors such as possible accumulations of water or cerumen in the vicinity of the electrode arrangement 24 is reduced, because such interference factors are to be expected with a particularly high probability near the periphery of the coil (in particular at the edges of the dome-shaped bulge of the end face 53 shown in FIGS. 1 to 3).

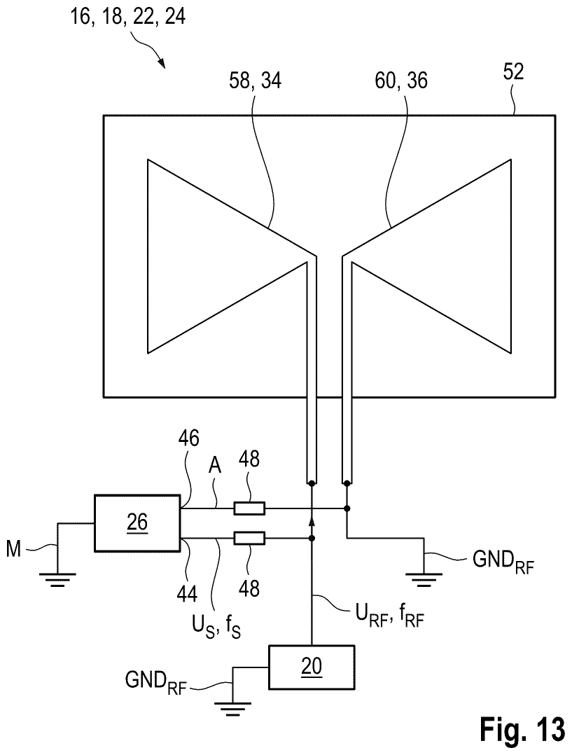

FIG. 13 shows another embodiment, in which the antenna 18 is embodied as a “butterfly antenna” (“bowtie antenna”). In this embodiment, the antenna 18 has two antenna segments 58 and 60 which are again galvanically separated from one another and whose width increases as the distance from the respective other antenna element 60 or 58 increases. For example, the two antenna segments 58 and 60 each have a triangular (as shown in FIG. 13) or, alternatively, a drop-like or circular segment-like shape, and each faces the other with a tapered end. The two antenna segments 58 and 60 are each energized at this end (facing toward the other antenna element 60 or 58). For this purpose, the antenna segment 58 is connected to the transceiver 20 in order to supply the alternating voltage U_{RF}, whereas the antenna segment 60 is connected to the ground potential GND_{RF} of the communication device 16.

The sensor control 26 of the capacitive control unit 22 is in turn connected to the antenna segment 58 via the control output 44 and to the antenna segment 60 via the measurement input 46, a low-pass filter 48 being in turn connected upstream from the measurement input 46 and—preferably—the control output 44, analogously to the embodiment according to FIGS. 7 and 8. In its mounting position in the housing 4 of the hearing instrument 2, the antenna 18, in turn, is arranged close beneath the front surface 53 according to FIG. 13.

Another embodiment of the antenna 18 (not explicitly shown) is formed from a combination of a spiral antenna and a butterfly antenna. In this embodiment, the two antenna segments 30 and 32 are each formed from a spiral arm of a double spiral antenna whose outer end widens outward in the manner of a wing of a butterfly antenna to form, for example, a triangular, drop-shaped, or circular segment-shaped surface.

The invention is made especially clear by the exemplary embodiments described above, but it is by no means limited thereto. Rather, additional embodiments of the invention can be derived from the claims and the above description.

The following is a summary list of reference numerals and the corresponding structure used in the above description of the invention:
hearing instrument
4 housing
6 microphone
8 receiver
10 printed circuit board
12 signal processor
14 battery
16 (wireless) communication device
18 (RF) antenna
20 transceiver
22 (capacitive) control unit
24 electrode arrangement
26 sensor control
28 sound channel
30 antenna segment
32 antenna segment
34 electrode
36 electrode
38 central surface
40 central surface
42 axis
44 control output
46 measurement input
47 finger
48 low-pass filter
49 connection point
50 high-pass filter
51 high-pass filter
52 (antenna) support
53 end face
54 arm
56 arm
58 antenna segment
60 antenna segment
f_{RF} radio frequency
f_{S} sensor frequency
A response signal
E_{RF} electrical component (of the electromagnetic field of the antenna 18)
E_{S} sensor field
GND_{FR} ground potential (of the communication unit 16)

M ground

U_{RF} alternating voltage

U_{S} sensor voltage

1. A hearing instrument, comprising:
a housing to be worn behind a user's ear or in a user's ear;
a wireless communication device disposed in said housing, said wireless communication device having a transmitting and receiving unit and an antenna electrically connected to said transmitting and receiving unit; and
a capacitive control unit with a control and evaluation circuit and an electrode arrangement electrically connected to said control and evaluation circuit;
said antenna of said wireless communication device also forming said electrode arrangement of said capacitive control unit, with said antenna having two antenna sections that are galvanically separated from one another, and said two antenna sections being electrically connected, separately from one another, to said control and evaluation circuit of said capacitive control unit and forming electrodes of said electrode arrangement.

2. The hearing instrument according to claim 1, wherein:
said transmitting and receiving unit of said wireless communication device is configured to generate and receive a first electrical alternating-current signal at a first frequency;
said control and evaluation circuit of said capacitive control unit is configured to generate and detect a second electrical alternating-current signal at a second frequency; and
the first frequency is higher than the second frequency by at least a factor of 10.

3. The hearing instrument according to claim 2, wherein the first frequency is higher than the second frequency by at least a factor of 100.

4. The hearing instrument according to claim 1, wherein said control and evaluation circuit of said capacitive control unit is configured to apply the second alternating-current signal to one of said two sensor electrodes and to measure a response signal which is characteristic of a capacitance of said electrode arrangement at the other one of said two sensor electrodes.

5. The hearing instrument according to claim 1, wherein said antenna has a shape of a multiple spiral with at least two intertwined spiral arms.

6. The hearing instrument according to claim 5, wherein each of said spiral arms widens in a center of the spiral.

7. The hearing instrument according to claim 6, wherein said spiral arms widen to form a partially circular disc-shaped or comb-shaped central structure.

8. The hearing instrument according to claim 1, wherein said antenna is a butterfly antenna.

9. The hearing instrument according to claim 1, wherein said antenna is mounted on a convex antenna support.

10. The hearing instrument according to claim 9, wherein said antenna support is elastically deformable through exertion of pressure on said housing.
